(19) United States
(12) Patent Application Publication
(10) Pub. No.: US 2018/0334897 A1
(43) Pub. Date: Nov. 22, 2018

(54) DRILLING CONTROL BASED ON BRITTLENESS INDEX CORRELATION

(71) Applicant: Landmark Graphics Corporation, Houston, TX (US)

(72) Inventors: Robello SAMUEL, Cypress, TX (US); Zhengchun LIU, Sugar Land, TX (US); Yu CHEN, Houston, TX (US); Jie HE, College Station, TX (US)

(21) Appl. No.: 15/779,494

(22) PCT Filed: Dec. 31, 2015
(86) PCT No.: PCT/US2015/068320

§ 371 Date: May 25, 2018

(51) Int. Cl. E21B 44/02; E21B 49/00; E21B 7/04; G01V 5/10; G01V 1/30

(52) U.S. Cl. CPC E21B 44/02; E21B 49/003; G01V 2210/6222; G01V 5/10; G01V 1/306; E21B 7/04

(57) ABSTRACT

Automated planning, control and/or geosteering assistance for a subterranean drilling operation is performed using an analytical drilling performance model that is a function of a rock brittleness index that is correlated with a corresponding formation property metric which serves as brittleness correlate and for which applicable measurement values are available from log data pertaining to the relevant formation. Correlation between the brittleness index and the brittleness correlate is such that a particular brittleness correlate value indicates a unique corresponding brittleness index value. One embodiment of the drilling performance model expresses rate of penetration as a function of a B4 brittleness index correlated with a sonic log brittleness correlate provided by pressure-wave velocity.

### BACKGROUND

Wellbores are formed in subterranean formations for various purposes including, for example, the extraction of oil and natural gas. Such wellbores are typically formed using a drill string having at its downhole end a bottomhole assembly (BHA) that includes a drill bit. A well path to be followed by the drill bit through the formation is typically planned based on survey measurements that indicate formation structure and properties. Such drilling operations often provide for geosteering of the BHA based on the planned well path and on substantially real-time measurement of formation properties in a logging while drilling (LWD) operation performed using measurement tools forming part of the BHA.

The BHA typically has a number of controllable drilling parameters (for example, speed of rotation of the drill bit, weight exerted on the bit, and the flow rate of drilling fluid through the bit) that influence drilling performance measures such as the rate of penetration (ROP) and/or specific energy of the drilling operation. Some drilling operations include calculating desirable values for the drilling parameters based on one or more models that predict a drilling performance measure. Accurate prediction of such drilling performance measures is often frustrated, however, by variations in formation properties.

### BRIEF DESCRIPTION OF THE DRAWINGS

Some embodiments are illustrated by way of example and not limitation in the figures of the accompanying drawings in which:

FIG. 1 depicts a schematic view of a drilling installation that includes a drill string configured for automated operational well planning and/or control based on real-time capturing of a brittleness correlate metric by logging tools forming part of the drill string, according to an example embodiment.

FIG. 2 depicts a schematic side view of a bottomhole assembly forming part of a drill string, according to an example embodiment.

FIG. 3 depicts a series of correlation graphs, each of which illustrates a respective correlational relationship between a brittleness index and a corresponding brittleness correlate provided by a particular formation property metric measurable in a logging while drilling operation.

FIG. 4 depicts a schematic flow diagram for automated prediction, based on LWD log data, of a rate of penetration (ROP) using a drilling performance model that expresses ROP as a function of a brittleness index directly correlated with one or more formation property metrics indicated by the log data, according to one example embodiment.

FIG. 5 depicts a schematic diagram for recursive determination of a rate of penetration and a bit wear function based on a brittleness index and formation log data, according to one example embodiment.

FIG. 6 depicts a simplified schematic diagram of a system that is configured to execute methods of well planning and/or automated drilling control according to an example embodiment.

FIG. 7 depicts a schematic flow diagram of a method of automated control of a subterranean drilling operation using real-time log data, according to one example embodiment.

FIG. 8 depicts a high-level flow diagram of a method of automated drilling operation planning and/or control, according to an example embodiment.

FIG. 9 depicts a schematic diagram of an exemplary computer subsystem forming part of a system for planning and/or control of a drilling operation, in accordance with one example embodiment.

### DETAILED DESCRIPTION

One aspect of the disclosure provides for a system for automated planning and/or control of a drilling operation using an analytical drilling performance model that is a function of a rock brittleness index, with the rock brittleness index being correlated with a corresponding formation property metric available from log data pertaining to the relevant formation. In some embodiments, the model uses a correlation established between the brittleness index and sonic pressure-wave velocity, for which measurement values can be obtained from a sonic log that may be generated in a logging while drilling (LWD) operation. Instead, or in addition, the model in some embodiments uses a correlation established between brittleness index and formation porosity values indicated by a neutron density log.

In this disclosure, brittleness correlate means a formation property metric that is directly correlated with a corresponding brittleness index, so that a particular value for the brittleness correlate indicates, by correlation, a particular value of the corresponding brittleness index. Differently defined the brittleness index is capable of being expressed as a function of the corresponding brittleness index only. In some embodiments, p-wave velocity serves as brittleness correlate. In some embodiments, formation porosity is used as brittleness correlate. From the description that follows, however, it will be understood that another aspect of the invention provides for a method comprising: identification based on empirical or experimental data of formation property-brittleness index correlations other than those described explicitly herein; and configuring a drilling system or geosteering analyzer to perform automated drilling parameter determination and/or optimization based at least in part on one or more of such different brittleness correlations.

In some embodiments, a ROP model expresses predicted rate of penetration of a drilling operation as a function the rock brittleness index. Based on a correlation between the brittleness index and a particular corresponding formation property that serves as a brittleness correlate (e.g., sonic p-wave velocity or formation porosity), the ROP model is thus expressed directly or indirectly as a function of the brittleness correlate. Substantially real-time values for the brittleness correlate is in some embodiments obtained from real-time LWD gamma ray log data, sonic log data, and/or porosity log data gathered by a bottomhole assembly (BHA) of which the drill bit forms part. Drilling parameter optimization may comprise maximizing ROP based on the model, e.g., by finding values for those drilling parameters forming part of the model at which the ROP value returned by the model is at a maximum.

Instead of, or in addition to the ROP model, some embodiments provides for well planning and/or drilling parameter optimization and control based on minimizing an drilling performance model that expresses mechanical specific energy or hydromechanical specific energy as a function of a brittleness index correlated with a corresponding formation property obtainable from LWD log data. In some instances, system components configured for automated drilling parameter determination is configured to minimize an expression for mechanical and/or hydromechanical specific energy based directly on the particular formation property that is used as brittleness correlate.

The following detailed description describes example embodiments of the disclosure with reference to the accompanying drawings, which depict various details of examples that show how various aspects of the disclosure may be practiced. The discussion addresses various examples of novel methods, systems, devices and apparatuses in reference to these drawings, and describes the depicted embodiments in sufficient detail to enable those skilled in the art to practice the disclosed subject matter. Many embodiments other than the illustrative examples discussed herein may be used to practice these techniques. Structural and operational changes in addition to the alternatives specifically discussed herein may be made without departing from the scope of this disclosure.

In this description, references to “one embodiment” or “an embodiment,” or to “one example” or “an example” in this description are not intended necessarily to refer to the same embodiment or example; however, neither are such embodiments mutually exclusive, unless so stated or as will be readily apparent to those of ordinary skill in the art having the benefit of this disclosure. Thus, a variety of combinations and/or integrations of the embodiments and examples described herein may be included, as well as further embodiments and examples as defined within the scope of all claims based on this disclosure, as well as all legal equivalents of such claims.

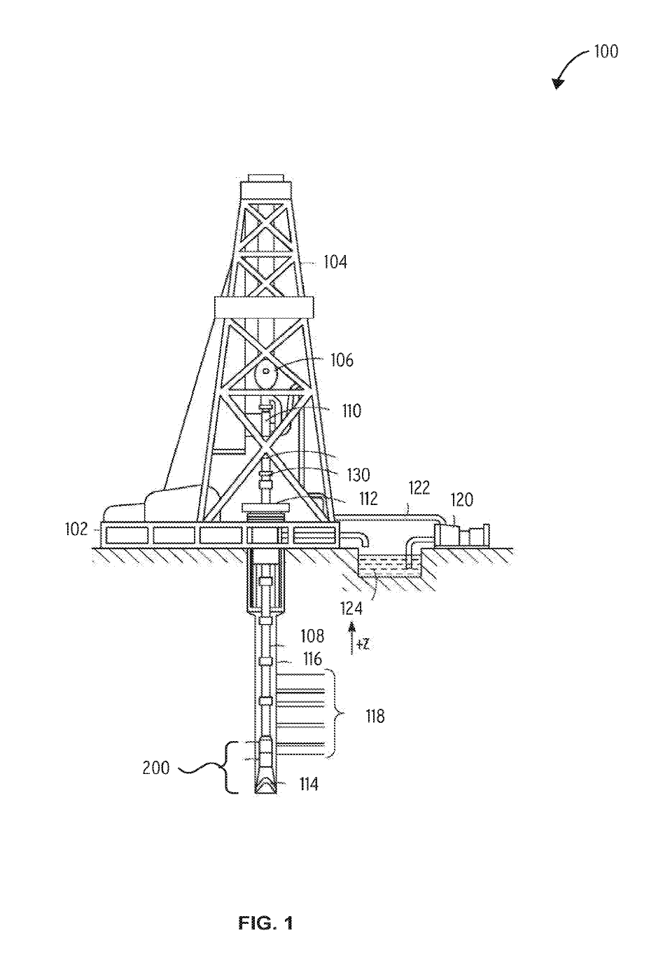

FIG. 1 is a schematic illustration of an example drilling system 100 that embodies techniques consistent with this disclosure in a logging while drilling (LWD) environment. A drilling platform 102 is equipped with a derrick 104 that supports a hoist 106 for raising and lowering a drill string 108. The hoist 106 suspends a top drive 110 suitable for rotating the drill string 108 and lowering the drill string 108 through the wellhead 112. Connected to the downhole end of the drill string 108 is a drill bit 114 that forms part of a bottomhole assembly (BHA 200), As the bit 114 rotates, it creates a borehole 116 that passes through a formation 118 containing hydrocarbons that are to be extracted via the borehole 116. A pump 120 circulates drilling fluid through a supply pipe 122 to top drive 110, down through the interior of the drill string 108, through orifices in bit 114, back to the surface via an annulus around drill string 108, and into a retention pit 124. The drilling fluid transports cuttings from the borehole 116 into the pit 124 and aids in maintaining the integrity of the borehole 116. Various materials can be used for drilling fluid, including a salt-water based conductive mud.

Although the drilling system 100 is shown and described in FIG. 1 with respect to a rotary drill system, it will be appreciated that many types of drilling systems can be employed in carrying out embodiments consistent with the disclosure. For instance, drills and drill rigs may in some embodiments be used onshore (as depicted in FIG. 1) or offshore (not shown). Offshore oil rigs that may be used in accordance with embodiments of the disclosure include, for example, floaters, fixed platforms, gravity-based structures, drill ships, semisubmersible platforms, jack-up drilling rigs, tension-leg platforms, and the like. Further, although described herein with respect to oil drilling, various embodiments of the disclosure may be used in many other applications. For example, disclosed techniques can be used in drilling for mineral exploration, environmental investigation, natural gas extraction, underground installation, mining operations, water wells, geothermal wells, and the like.

Furthermore, aspects of the disclosure pertaining to formation logging and well planning or drilling parameter optimization can in some instances be performed with respect to wireline logging or analogous measurement environments, before or in parallel to real-time operational control of a drill string 108 such as that illustrated in FIG. 1.

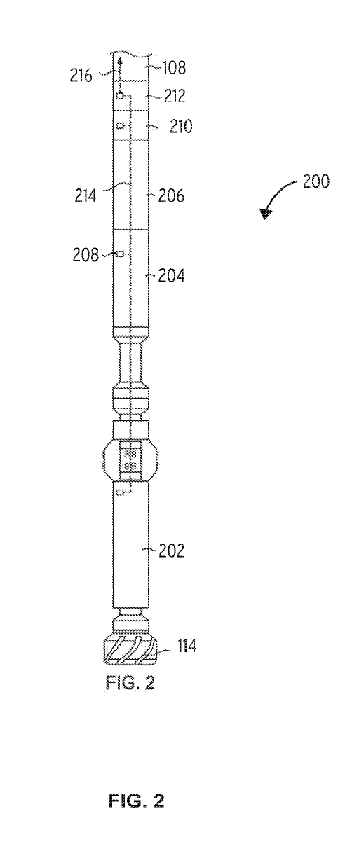

Referring now to FIG. 2, with continued reference to FIG. 1, illustrated is an exemplary BHA 200 that can be used in accordance with one or more embodiments of the present disclosure. As illustrated, the BHA 200 may include at least the drill bit 114, a steering assembly 202 operatively coupled to the drill bit 114, a measuring tool 204, and a drill collar 206.

The steering assembly 202 may be any type of downhole steering system or device configured to orient the drill bit 114 such that a planned trajectory or wellbore path is followed. In some embodiments, the steering assembly 202 may be a rotary steerable tool. In other embodiments, the steering assembly 202 may be a mud motor or any other known device or system that may reorient the trajectory of the drill bit 114, without departing from the scope of the disclosure. Some embodiments may provide for automated optimization and control of drilling parameters (such as weight on bit, rotational bit speed, and fluid flow rate) without associated automated steering control. In such embodiments, the disclosed techniques may be employed using embodiment assembly without a steering assembly.

The measuring tool 204 includes a measuring while drilling (MWD) sensor package that may include one or more survey probes 208 configured to collect and transmit directional information, mechanical information, formation information, and the like. In particular, the one or more survey probes 208 may include one or more internal or external sensors such as, but not limited to, an inclinometer, one or more magnetometers, (i.e., compass units), one or more accelerometers, a shaft position sensor, combinations thereof, and the like. Directional information (i.e., wellbore trajectory in three-dimensional space) of the BHA 200 within the earth (FIG. 1), such as inclination and azimuth, may be obtained in real-time using the survey probes 208.

The measuring tool 204 in this example embodiment further includes a (LWD) sensor package that may include one or more sensors configured to measure formation parameters such as resistivity, porosity, sonic propagation velocity, neutron density, or gamma ray transmissibility. As the bit 114 extends the borehole 116 through the formation 118, the measuring tool 204 collects measurements relating to various formation properties, while the MWD sensor package collects measurements relating to tool orientation and various other drilling conditions.

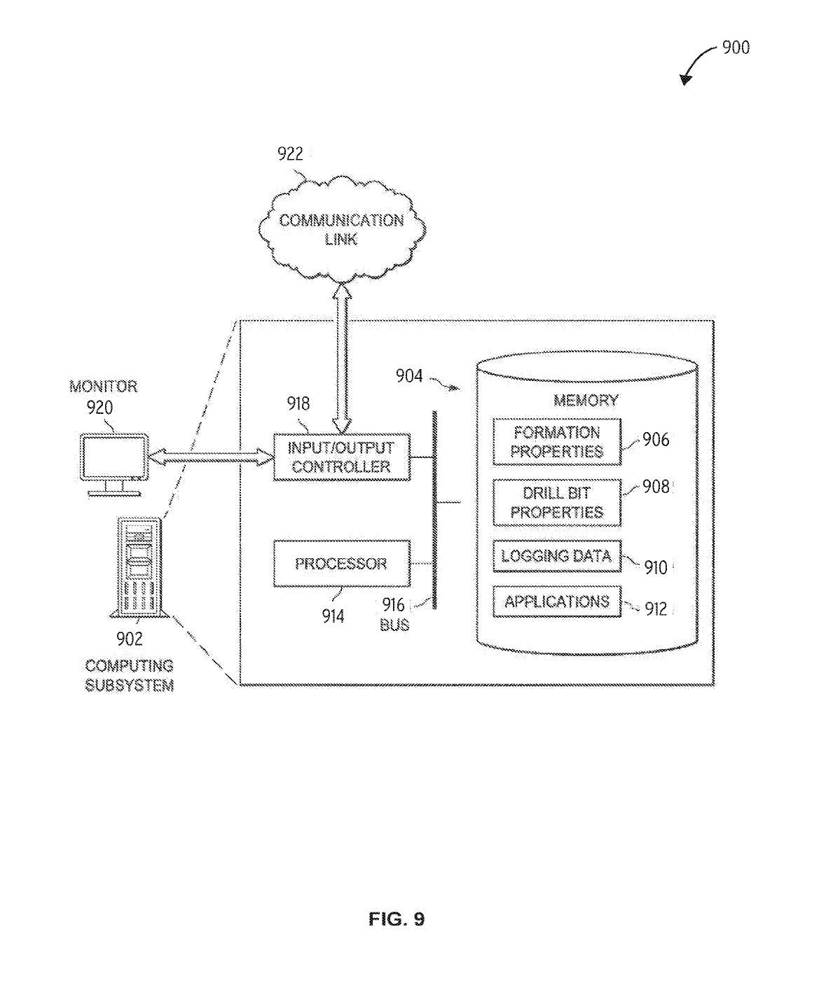

In some embodiments, the MWD and LWD tools, and their related sensor packages, may be in communication with one another to share collected data therebetween. The measuring tool 204 can be battery driven or generator driven, as known in the art, and any measurements obtained from the measuring tool 204 can be processed either at the surface (see, for example, FIG. 9) or at a downhole location.

The drill collar 206 may be configured to add weight to the BHA 200 above the drill bit 114 so that there is sufficient weight on the drill bit 114 to drill through the requisite geological formations. Weight may also be applied to the drill bit 114 through the drill string 108 as extended from the surface.

The BHA 200 may further include a sensor sub 210 coupled to or otherwise forming part of the BHA 200. The sensor sub 210 may be configured to monitor various operational parameters in the downhole environment with respect to the BHA 200. For instance, the sensor sub 210 may be configured to monitor operational parameters of the drill bit 114 such as, but not limited to, weight-on-bit (WOB), torque-on-bit (TOB), rotational speed of the drill bit 114 (expressed here as rotations per minute (RPM)), bending moment of the drill string 108, vibration potentially affecting the drill bit 114, and the like. In some embodiments, the sensor sub 210 may be a DRILLDOC® tool commercially-available from Sperry Drilling of Houston, Tex., USA. The DRILLDOC® tool, or another similar type of sensor sub 210, may be configured to provide real-time measurements of weight, torque and bending on an adjacent cutting tool (i.e., the drill bit 114) and/or drill string 108 to characterize the transfer of energy from the surface to the cutting tool and/or drill string 108. As will be evident from the description that follows, these measurements are used in automated optimization to maximize performance and minimize wasted energy transfer and vibration of drilling parameters based on substantially real-time measurement of formation properties by the measuring tool 204.

The BHA 200 may further include a controller module 212 coupled to or otherwise forming part of the BHA 200. The controller module 212 may be a downhole computer system communicably coupled to each of the sensor sub 210, the measuring tool 204 (e.g., its survey probes 208) and the steering assembly 202 via one or more communication lines 214. Via the communication lines 214, the controller module 212 may be configured to send and receive data and commands to/from the sensor sub 210, the measuring tool 204, and the steering assembly 202 substantially in real time.

In some embodiments, the controller module 212 may further be communicably coupled to the surface (FIG. 1) via one or more communication lines 216 such that it is able to send and receive data in real time to/from the surface (FIG. 1) during operation. The communication lines 214 and/or the communication lines 216 may be any type of wired telecommunications devices or means known to those skilled in the art such as, but not limited to, electric wires or lines, fiber optic lines, etc. Alternatively or additionally, the controller module 212 may include or otherwise be a telemetry module used to transmit measurements to the surface wirelessly, if desired, using one or more downhole telemetry techniques including, but not limited to, mud pulse, acoustic, electromagnetic frequency, combinations thereof, and the like.

During drilling operations using the BHA 200, a number of drilling parameters can be controlled to influence at least some performance measures of the drilling operation. In this example embodiment, these controllable drilling parameters include:

(a) weight on bit (WOB), being the amount of force exerted on the drill bit 114 along the drill string, acting substantially in the direction of the borehole axis at the BHA 200;

(b) rotational speed of the drill bit 114, in this example expressed as rotations per minute (RPM); and

(c) flow rate of pressurized drilling fluid through the drill bit 114 (Q).

Drilling optimization and control in this example embodiment comprises defining a drilling performance model that expresses a drilling performance measure as a function of one or more of the controllable drilling parameters and as a function of one or more formation property metrics, and optimizing the efficiency expression to determine estimated optimal values for the respective drilling parameters. In some embodiments, the analytical drilling performance model expresses a rate of penetration (ROP) of the drill bit 114 through the rock formation 118. Instead, or in addition, the drilling performance model expresses a mechanical specific energy (MSE) of the drilling operation. Yet further, the drilling performance model can in some embodiments express a hydromechanical specific energy (HMSE) of the drilling operation. Some embodiments may provide for well planning and/or drilling optimization based on use of two or more of the above-mentioned efficiency models.

The present example embodiment provides for expressing one or more performance measures of the drilling performance model(s) as a function of a rock drillability index (RDI) that quantifies drillability of the formation 118 at the BHA 200. In this example embodiment, the drilling performance model provides an analytical model for rate of penetration expressed as follows:

ROP=G×W_{f}/D_{b}×RDI×WOB^{a}×RPM^{b}× Equation (1)

where:

G, a, b, and c are model constants;

W_{f} is a bit wear function providing a value for wear on the drill bit 114 between 0 and 1;

D_{b} is bit diameter; and

RDI is the rock drillability index.

The rock drillability index, is, in turn, a function of a brittleness index or value indicative of the rock brittleness of the formation 118. In this example embodiment, the rock drillability index is expressed as follows:

RDI=1/Bₙ/(1+a*Pₑ^{b}) Equation (2)

where:

Bₙ is the rock brittleness index;

a and b are the model constants of Equation (1) and are dependent on rock permeability; and

Pₑ is the differential pressure between bottomhole pressure and pore pressure of the formation 118 (i.e., the differential pressure between fluids in the borehole and in the formation 118 at the relevant position along the borehole 116).

Any one of a plurality of different brittleness indices (Bₙ) for which there has been established a correlation with one or more of the measurable formation property metrics can be used, depending on available log data, pre-established brittleness correlation data, design choice, and/or operator preferences. As will be seen from what follows, substitution of the brittleness index in Equation (2) with a particular correlation between the brittleness index and a corresponding formation property (which thus serves as brittleness correlate), therefore results in direct or indirect expression of the drilling performance model of FIG. 1 as a function of the brittleness correlate.

The techniques of this disclosure are based in part on the identification or establishment of a correlation between a particular formation log metric and a corresponding brittleness index (Bₐ). Brittleness index indicate the relative measure of Young's modulus (YM) and Poisson's ratio (PR) for the relevant formation. Existing techniques provide for calculation of brittleness index values using dynamic YM and PR from compressional and shear slowness from a dipole sonic. This is then converted to static measurement based on core calibration and local correlation.

This disclosure, however, provides for brittleness determination and ROP, MSE and/or HMSE estimation based on the calculated brittleness not only in static mode but also in dynamic mode and substantially in real-time. Estimated drillability of the rocks is thus adjusted based on the calculated brittleness. As will be seen from what follows, the disclosed techniques can also be used for surface and/or downhole automation in conventional drilling as well as in geo-steering applications.

As mentioned previously, a formation log metric that is directly correlated to a corresponding brittleness index, so that a particular measurement value of that formation log metric directly indicates by correlation a corresponding brittleness index value, is referred to herein as a brittleness correlate. Some embodiments can provide for use of a number of different such brittleness correlations. Thus, for example, a plurality of different brittleness correlates can be used in drilling parameter optimization or well planning. Instead, or in addition, a plurality of different brittleness indices can be correlated with a single formation log metric.

In one example embodiment of the disclosed techniques, a novel correlation between rock brittleness indices and p-wave velocity of a sonic log is employed. For example, one rock brittleness index (B4) is defined as follows:

B4=sqrt(σₜ*σ_{c})/2 Equation (3)

where

σₜ is tensile rock strength; and

σ_{c} is compressive rock strength.

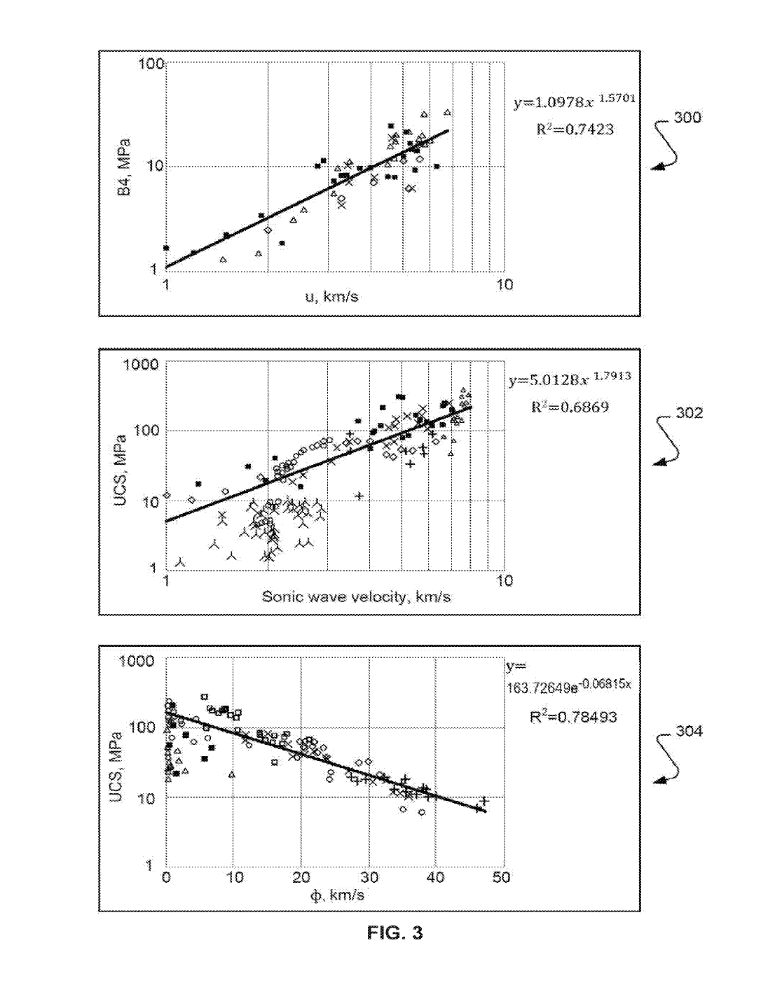

The inventors developed a correlation between the B4 brittleness index and sonic log pressure wave velocity based on empirical data. In FIG. 3, this correlation is graphically illustrated by logarithmic-scale graph 300 representing B4 values (y-axis for a range of different formations against corresponding sonic pressure wave velocity (x-axis). The correlation as derived is expressed mathematically as:

B4 (MPa)=1.0978u^{1.5701} Equation (4)

where u is p-wave velocity, km/s.

It will be noted from the correlation expressed by Equation (4) that the brittleness index B4 is a function of a single variable, namely the p-wave velocity (u). The brittleness index is thus directly correlated to the p-wave velocity, in that a particular measured value for p-wave velocity directly indicates, by correlation, a unique corresponding B4 value. It will thus be seen that p-wave velocity is identified as brittleness correlate, being directly correlated with a corresponding brittleness index (B4). P-wave velocity is moreover a formation property metric that is directly measurable by LWD tools such as that incorporated in the measuring tool 204 of the example BHA 200. Measurement values for p-wave velocity thus form part of sonic log data captured by the BHA 200 in this example embodiment.

Note that the B4-sonic velocity correlation discussed in this example embodiment may in other embodiments be replaced or augmented with one or more different correlations between measured formation property metrics and corresponding brittleness indices. New correlations were also, for example, developed between rock strength and petrophysical/geomechanical properties of the rock (such as Young's modulus, p-wave velocity, and velocity). In such examples, a derived rock strength value (in this case, unconfined compressive strength (UCS)) may be employed as brittleness index (Bₐ) in Equation (2). Graphs 302 and 304 in FIG. 3 show two examples of such correlations between rock strength (UCS) and respective corresponding formation. Graph 302 shows a direct correlation between UCS (expressed in MPa) and sonic wave velocity. Graph 304 represents a correlation developed between unconfined compressive strength and rock porosity (4).

Although the disclosed methods and systems will further be described with reference to the identified correlation between the B4 brittleness index and sonic p-wave velocity (see graph 300, FIG. 3), it will be appreciated that analogous optimization expressions to those described below can be developed based on Equations (1) and (2) using different brittleness indices and/or correlations, such as, for example, the correlations of graphs 302 and 304. Other formation property metrics or log data for which brittleness correlations may be developed and which may thus be used as brittleness correlate for well planning and/or drilling parameter optimization include, but are not limited to: minerological information provided by an elemental analysis tool such as, for example, Halliburton's GEM™ tool; density; total organic carbon and Kerogen; pseudo-brittleness; vertical vs horizontal stresses; permeability, formation integrity values, free and adsorbed accumulated gas; 2D vs 3D stress; and formation anisotropy.

Note also that the discussed correlations are global in the sense that they represent experimental data for different rock types (igneous, metamorphic, and sedimentary) from various locations across the world. These correlations can therefore be applied to all sorts of pathology encountered in the petroleum industry, including sandstone, carbonate, and shale rocks.

Returning now to the present example embodiment in which the wellbore planning and drilling parameter optimization is performed based on the correlation between the B4 brittleness index and sonic p-wave velocity, substitution of Equation (4) in Equation (3) delivers expression of the rock drillability index as:

RDI=1/1.0978*u^{-1.5701}/(1+aₛ×Pₑ^{b}^{ₛ}) Equation (5)

The drilling performance model of Equation (1), modeling the rate of penetration of the drill bit 114 is in turn provided by:

ROP=G×W_{f}/D_{b}×[1/1.0978*u^{-1.5701}/(1+aₛ×Pₑ^{b}^{ₛ})]×WOB^{a}×RPM^{b}×Q^{c}, Equation (6)

It can thus be seen that the drilling performance model of Equation (6) is a function of the sonic p-wave velocity of the rock formation 118, being in this example the brittleness correlate represented in log data captured by the measuring tool 204.

Equation (6), or its equivalent using a different brittleness index and/or brittleness correlate, is in this example further used in calculating an additional drilling performance model that models hydromechanical specific energy (HMSE or Eₛ), which can be expressed as follows:

$${E}_{s} = \frac{W}{A} + \frac{2 π NT}{AROP} + \frac{Δ PQ}{AROP} \qquad Equation ( 7 )$$

where:

A is the cross-sectional area of a hole drilled by the drill bit 114;

W is the weight-on-bit (WOB) as in Equation (1);

N is the rotational speed of the drill bit, corresponding to RPM in Equation (1);

T is torque applied to the drill bit 114;

ΔP is the difference and fluid pressure across the drill bit 114; and

Q is again the flow rate of pressurized drilling fluid through the drill bit 114.

Note that Equation (7) provides for calculation of hydromechanical specific energy for nonzero values of ΔP, and provides an expression for mechanical specific energy where ΔP is substantially zero. Using equations (6) and (7), the mechanical specific energy can thus be given as:

$${E}_{s} = \frac{W}{A} + \frac{8 μ {N}^{1 - b} {W}^{1 - a}}{3 {GW}_{f} RDI} \qquad Equation ( 8 )$$

where:

μ is a coefficient of friction between the drill hit 114 and the formation 118.

The rock drillability index (RDI) component in Equation (8) and/or the rate of penetration (ROP) component in Equation (7) can be expressed as a function of a particular brittleness correlate, to provide directly or indirectly for expression of the mechanical specific energy or hydromechanical specific energy as a function of the applicable formation property metric that serves as brittleness correlate. In this example embodiment, in which the correlation between the B4 index and p-wave velocity is employed, RDI can be substituted in Equation (8) using Equation (5) [1/1.0978**u^{-1.5701}/(1+aₛ×Pₑ^{b}^{ₛ})] to provide for expression of the mechanical specific energy of the drilling operation as a function of the p-wave velocity of the formation 118 at or adjacent the BHA 200.

In general, a simplified expression for hydromechanical specific energy based on combination of Equation (8) and Equation (2) can be given as:

$${E}_{s} = \frac{W}{A} + {KB}_{n}^{λ ( t )} \qquad Equation ( 9 )$$

### Where:

K is the applicable brittleness index; and

λ(t) is the correlation between the applicable brittleness index and the corresponding formation property metric that serves as brittleness correlate, which correlation is dynamically variable with variation in formation properties for different positions along the borehole 116, and which can be calculated in real-time.

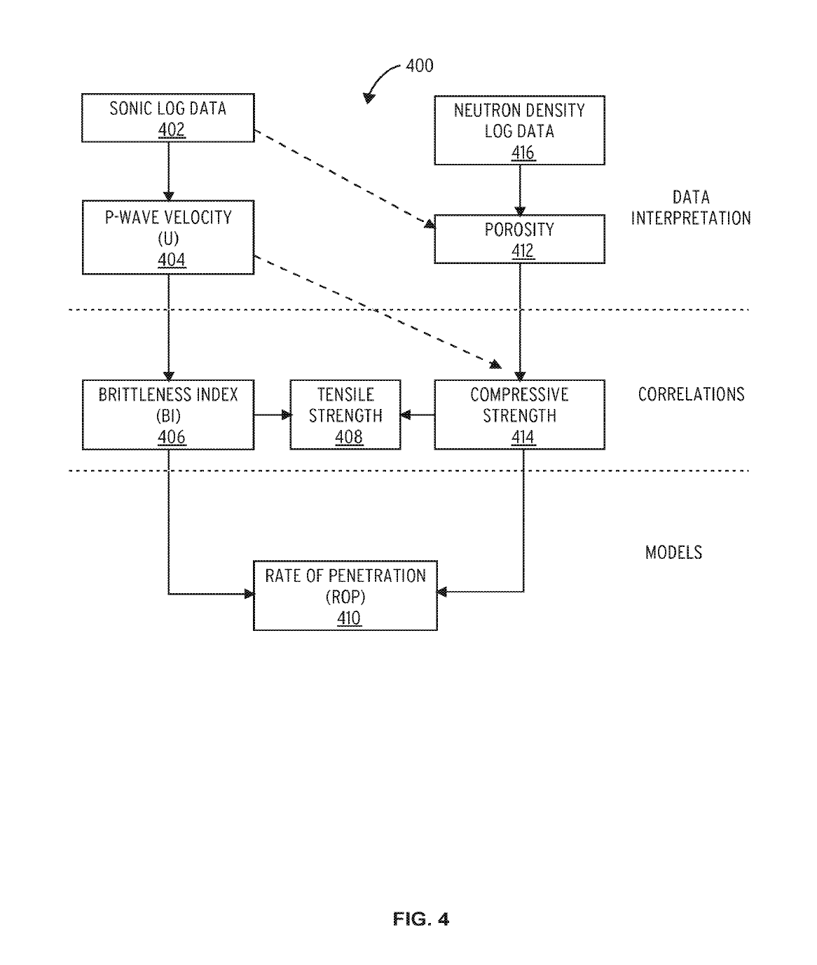

The above-described expressions are used together with log data gathered with respect to the formation and well planning, geosteering, and/or cost control of the drilling operation. FIG. 4 illustrates one example embodiment of a logical data flow diagram 400 illustrating one example embodiment in which automated prediction of the rate of penetration can be used for well planning, for real-time geosteering, and/or for cost control purposes. Thus, sonic log data, at block 402, is interpreted to establish measured values for p-wave velocity (uₚ), at block 404. The measured velocity data is used to determine the correlated brittleness index (BI), at block 406. In this example embodiment, the compressive wave velocity values are correlated with the B4 brittleness index according to Equation (4). At block 410, the predicted rate of preparation is calculated based on the sonic log data using Equation (6).

The rate of penetration can instead, or in addition, the predicted based on neutron density log data, at block 414, from which porosity values can be derived, at block 412. The porosity values indicate corresponding values for compressive strength (σ_{c}) of the formation, at block 416, based on the porosity-rock strength correlation 302 of FIG. 3. The compressive rock strength thus serves as corresponding brittleness index in such cases. Thereafter, the rate of penetration can be predicted, at block 410, by use of Equation (1) and Equation (2). It will be appreciated that these operations which are here described as separate steps can be contracted to performance in a single step, for example by defining ROP directly as dependent on p-wave velocity, as in Equation (6), and solving the resultant expression.

As indicated by the dashed line connecting block 402 and block 412 in FIG. 4, sonic log data can in some instances be used in calculating porosity values for the formation 118. Instead, or in addition, the derived values for p-wave velocity of the rock (u₁₃) can in some embodiments be used for calculating the compressive strength (σ_{c}), as indicated schematically in FIG. 4 by the dashed line connecting block 404 and block 414. Note that calculation of ROP penetration, at block 410, can comprise optimizing the ROP model to determine drilling parameter values (e.g., optimal values for WOB, RPM, and Q) corresponding to maximizing the ROP value. Such optimal drilling parameter values may then be used in well planning or in real-time geosteering of the BHA 200.

It will be appreciated that the diagram 400 of FIG. 4 provides one example embodiment of using brittleness correlations for well planning or geosteering, and that other embodiments may instead, or in addition, provide for analogous optimization of drilling efficiency expressions for other parameters, such as the mechanical specific energy and hydromechanical specific energy expressions represented by Equation (7) and Equation (8) above. Note further that log data and formation property metrics different from those illustrated in FIG. 4 may be employed in other embodiments, depending on the particular brittleness correlation(s) on which the optimization is based.

Returning now to FIG. 4, note that the brittleness index of block 406 can be used together with the compressive strength values of block 414 to calculate tensile strength (αₜ) of the formation 118, for example by use of Equation (3).

In some embodiments, the bit wear function (W_{f})—which provides a value for wear on the drill bit 114 between 0 and 1—may be expressed as a function of one or more of the components of the relevant drilling performance model. In some embodiments, for example, the bit wear function may be calculated according to techniques similar or analogous to those described in International Application no. PCT/US2015/014032 to Samuel, et al, filed Feb. 2, 2015, published as WO/2015/119875, and titled “Model for Estimating Drilling Tool Wear.”

In one example embodiment, the drill bit wear for a roller cone with chisel teeth is modeled as:

$${y}_{i} = \frac{Δ h}{h} = {( \frac{Δ V}{{V}_{0}} )}^{1 / 2} \qquad Equation ( 10 )$$

with:

$$Δ V = β {α}_{0} π {D}_{i} S \cdot WOB ( \frac{60 N \cdot X}{ROP} ) \qquad Equation ( 11 )$$

where:

V₀ is the starting volume per tooth of the bit;

ΔV is average volume loss per tooth;

β is a constant related to the geological formation and drill bit properties;

α₀ is the rock quartz content, which can be calculated based on gamma ray log data as discussed in the above-referenced prior patent application;

Dᵢ is the average diameter of a cylindrical representation of a cutting element;

S is confined compressive rock strength;

N is rotational speed of the drill bit; and

X is incremental advance of the drill bit through the formation.

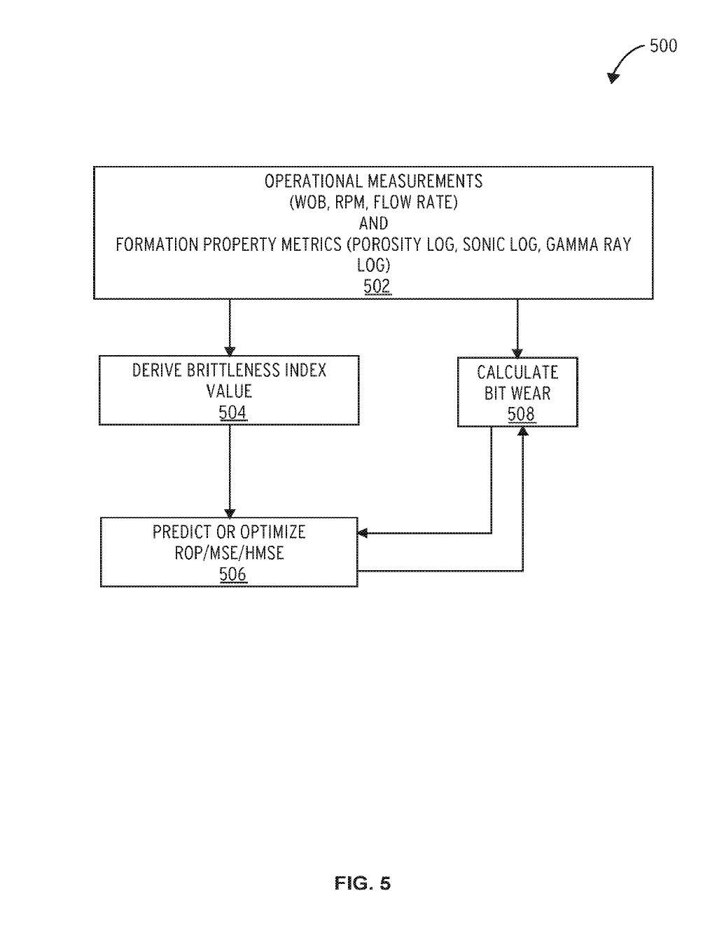

Because the drill bit wear (W_{f}) is in such an example embodiment a function of the ROP, which is in turn a function of the drill bit wear (W_{f}), linear resolution of these expressions is not feasible. In FIG. 5, flowchart 500 shows an example method of drilling efficiency prediction and/or drilling parameter optimization using recursive solution of the expressions for ROP and bit wear, respectively. Note that this flowchart 500 in some embodiments forms part of the optimization method described with reference to the diagram 400 of FIG. 4. At operation 502, survey measurements or operational measurements gathered by sensor sub 210 and formation property metrics gathered by measuring tool 204 or by prior logging using a wireline logging tool is obtained or accessed. At operation 504, one or more brittleness index values are determined based on the log data, using respective brittleness correlations as discussed previously. At operation 506, an optimized top predicted value for ROP is calculated based on Equation (6) (or based on an analogous to equation using a different brittleness correlate), using an estimated or a last calculated value for the bit wear function (W_{f}). Thereafter, the bit wear function (W_{f}) is calculated at operation 508, using the operational measurements, relevant log data, and the value for ROP calculated at operation 506. The resultant value for W_{f} is then used in operation 506 for recalculation or re-optimization of the ROP, producing an updated value which can again be used in W_{f} calculation in operation 508, and so forth. Such recursive calculation/optimization is repeated until the resultant values for ROP and W_{f} stabilize.

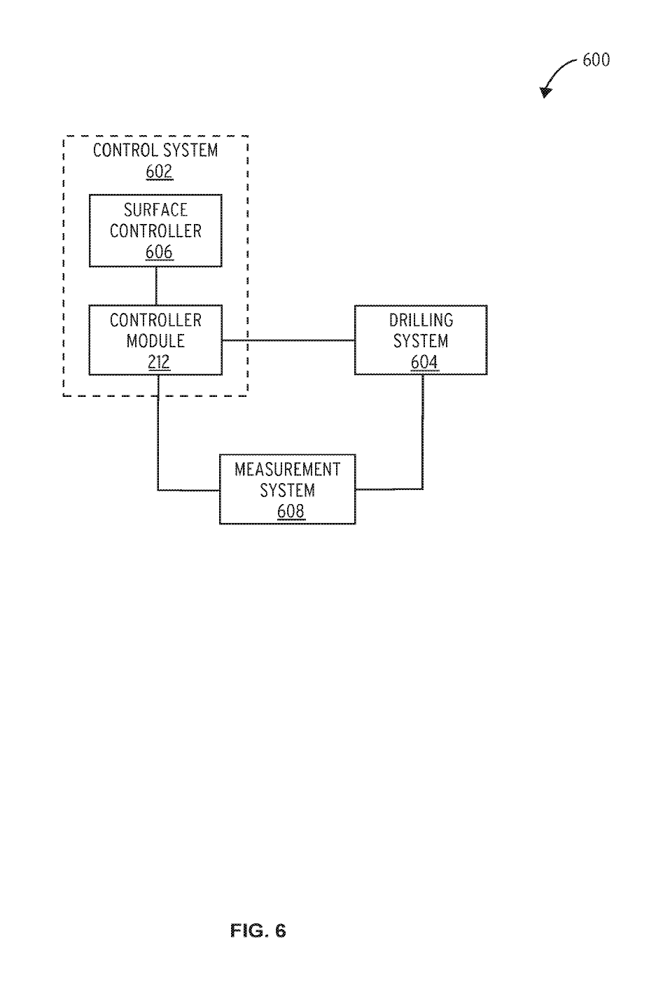

Referring now to FIG. 6, therein is illustrated a simplified schematic diagram of a system 600 that may be configured to execute the disclosed methods described herein, according to one or more embodiments. As illustrated, the system 600 may include a drilling system 604, for example comprising the drill string 108 of FIG. 1. The system 600 further includes a control system 602 that comprises the controller module 212, as generally described above with reference to FIG. 2, the controller module 212 being incorporated in the drill string 108. The control system 602 may in some embodiments further include a surface controller 606 cumulatively coupled to the controller module 212. The control the controller module 212, as generally described above with reference to FIG. 2, is communicably coupled to the drilling system 604 and a measurement system 608. The measurement system 608 may include, for example, the measuring tool 204 and the sensor sub 210 FIG. 2 in order to collect and transmit directional information, mechanical information, formation information, and the like. Updated directional information of the BHA 200 (FIG. 2), such as course length, inclination and azimuth, may be obtained and transmitted in real-time to the controller module 212 in the form of one or more measurement signals.

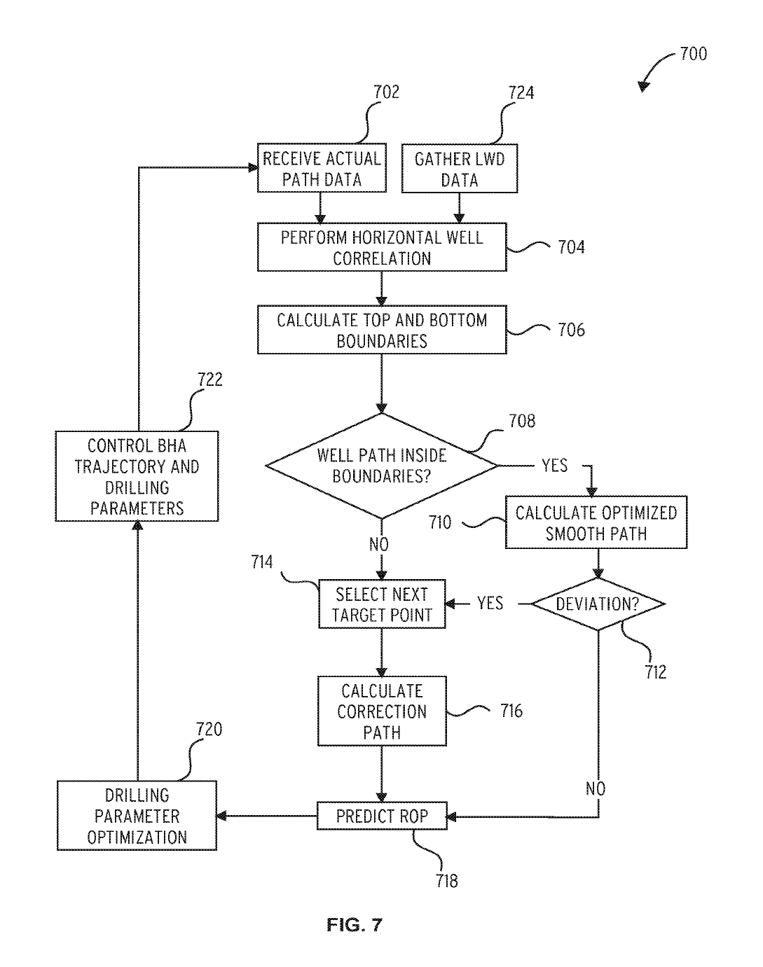

FIG. 7 shows a flowchart of one example embodiment of a method 700 for automated control of the drilling operation using substantially real-time log data, implemented using the example system components of FIG. 1, FIG. 2, and FIG. 6. In this example embodiment, the method 700 is described with reference to the drilling of an undulated well that extends more or less horizontally in a formation 118 defined between generally horizontal bed boundaries. It will be appreciated, however, the methods and systems described herein can in other embodiments be employed in the drilling of wells of any suitable kind or orientation.

At operation 702, the control system 602 receives and processes measurement signals gathered by the sensor sub 210 and indicating, inter alia, actual path data representing an actual path described by the BHA 200 in drilling the borehole 116. The controller module 212 may include a processing unit that may be configured to receive and process the measurement signals. In some embodiments, the processing unit may be a proportional-integral-derivative (PID) controller module or system. As drilling progresses and advances within the subterranean formation 118 (FIG. 1), the measurement system 404 may be configured to continually take or otherwise obtain survey measurements corresponding to the real-time conditions of the drilling operation. In some embodiments, the survey measurements may be taken at specific survey points, but may equally be taken at any time during the drilling operation, without departing from the scope of the disclosure. Accordingly, as the drilling operation progresses, the controller module 212 is continually updated with real-time measurement data corresponding to directional information (i.e., real-time inclination and azimuth angles) of the BHA 200 (FIG. 2) and can then issue corrective command signals configured to maintain the actual wellbore path in-line with the planned wellbore path, as discussed below.

At operation 724, logging data indicative of one or more formation property metrics, as discussed previously, are continuously gathered by the measuring tool 204 forming part of the BHA 200. The DAM logging data may include, as mentioned previously, sonic logs, neutron density logs, gamma ray logs, resistivity logs, or the like. In this example embodiment, the logging data includes at least the brittleness correlate of p-wave velocity of the formation 118, as well as neutron density log data indicative of formation porosity, as described with reference to FIG. 4.

At operation 704, horizontal well correlation is performed using the LWD data gathered by the BHA 200 together with logging data gathered in one or more offset wells, thereby to dynamically update a geological module and structural framework on which the geosteering operation is based. Thereafter, top and bottom boundaries of a target zone within the formation 118 is automatically calculated, at operation 706. At operation 708, the control system 602 automatically determines whether or not the current position and projected position of BHA 200 is within the boundaries of the target zone.

If, at operation 708, it is determined that the well path is within the target zone boundaries, an optimized smooth path is calculated. Although there are many different methods for well path planning and optimization, the present example embodiment provides for calculation of the optimized smooth path based on minimizing wellbore profile energy, using techniques similar or analogous to those described in International Application PCT/US2013/057498, filed Aug. 30, 2013, titled “Automating Downhole Drilling Using Wellbore Profile Energy and Shape,” and published as WO/2015/030790.

As is often the case, however, the tool string may deviate from the original designed wellbore path and/or from the optimized smooth path and instead an actual wellbore path may result that is misaligned with or otherwise diverges from the original well bore path. Such deviations may result from several indirect variables such as, but not limited to, the rate of penetration of the tool string, the deflection of the tool string within varying rock types and/or formations, the toolface setting, rotation of the tool string (i.e., sliding or rotary, depending on the type of drilling motor), the wearing out of the drill bit 114 and other tools in the BHA 200, vibration in the drill string 108, combinations thereof, and the like. The control system 602 therefore determines, at operation 712, whether or not the well path has deviated from the optimized smooth path. If not, the method 700 proceeds to operation 718, in which an expression for ROP based on Equation (1) as described earlier is used together with substantially real-time LWD data to model the rate of penetration of the drilling operation. More on this later. If, however, determination at operation 712 indicates that the well path has deviated from the planned optimized path, a next target point along the planned well path is selected, at operation 714.

Returning now to operation 708, if it is determined that the well path is outside of the boundaries of the target zone, a next target point for returning to the planned well path is likewise selected, at operation 714. After selection of the next target point, at operation 714, a correction path for returning to the planned well path is calculated, at operation 716. A person skilled in the art will appreciate that there are several methods of redirecting the tool string to the planned path, this example embodiment again uses a trajectory control model that does so based on a minimum wellbore energy criterion in order to minimize overshoots and undulations of well trajectories, as described and detailed in the above-referenced International Application WO/2015/030790.

Whether or not the well path has deviated, and regardless of whether or not the well path is within the target zone boundaries of the formation 118, ROP prediction based on formation log data and brittleness correlation(s) is performed at operation 718, and drilling parameter optimization based on the ROP model is performed at operation 720.

The drilling efficiency model in drilling parameter optimization of operations 718 and 720 are performed according to the techniques described with reference to FIG. 4 and FIG. 5. Thus, in this example embodiment, sonic p-wave velocity velocities from the sonic log data serves as brittleness correlate for deriving the corresponding B4 brittleness index based on the brittleness correlation defined by Equation (4), as represented schematically in block 406 in FIG. 4 and block 504 in FIG. 5. Instead, or in addition, neutron density log data can be used to divide unconfined compressive strength values for the formation 118 by use of the porosity correlation 304 of FIG. 3.

A predicted rate of penetration is thus calculated, at operation 718, using Equation (6) together with current values for the drilling parameters WOB, RPM, and Q. As described with reference to FIG. 5, the ROP calculation is in this example embodiment performed in a recursive operation that calculates, in turn, estimated bit wear (W_{f}) and ROP.

At operation 720, optimized values for weight on bit (WOB), rotational speed (RPM), and drilling fluid flow rate (Q) are determined by optimizing a selected drilling performance model. In some embodiments, the drilling parameter optimization comprises maximizing the ROP expression of Equation (6). In other embodiments, the drilling parameter optimization comprises minimizing an analytical model for hydromechanical specific energy, such as that of Equation (7), or minimizing an analytical model for mechanical specific energy, such as that of Equation (8).

The target values for the drilling parameters are then used together with steering data regarding the planned well path and/or the calculated correction path to steer the control the trajectory of the tool string steer the BHA 200

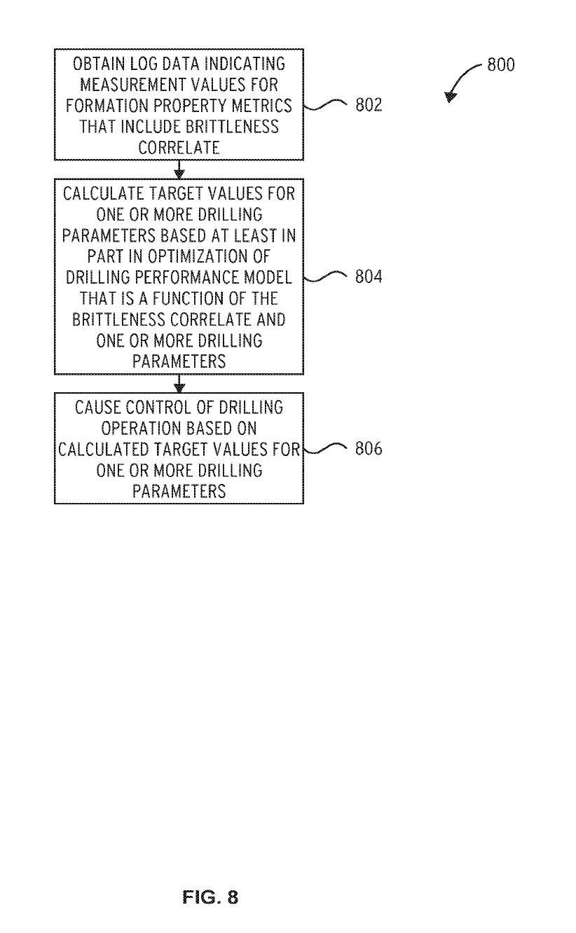

Turning now to FIG. 8, it will be seen based on the preceding detailed description that the described embodiments broadly disclose a method 800 for automated planning and/or control of a drilling operation, as depicted diagrammatically in the flowchart of FIG. 8. In operation 802, log data is obtained that indicates indicating measurement values for one or more formation property metrics captured with respect to an underground formation (e.g., a formation 118) through which a borehole (e.g., borehole 116) is to be drilled by use of a bottomhole assembly (e.g., BHA 200) forming part of a drill string (e.g., drill string 108). Obtaining the log data in some embodiments comprise gathering of the log data using the measuring tool 204 of the BHA 200. In other embodiments, operation 802 may comprise retrieving or accessing log data from a log memory, or receiving the log data from a separate measuring tool or system.

In operation 804, target values for one or more drilling parameters are calculated based on the log data and using a drilling performance model that is a function of at least the brittleness correlate and the one or more drilling parameters (e.g., Equation (6)).

The method 800 further includes, at operation 806, causing control of a drilling operation based on the calculated target values for the drilling parameters. Operation 806 in some embodiments comprise automated adjustment and control of the BHA 200. Instead, or in addition, operation 806 may comprise display of well planning and/or drilling control data that includes the calculated drilling parameters to an operator on a display screen.

The disclosed methods and systems provide a number of benefits over existing techniques. Use of analytical drilling performance models that accounts for rock drillability by correlation with a directly measurable brittleness correlate not only allows for drilling parameter optimization that is sufficiently fast to allow substantially real-time drilling control, but also provides for improved accuracy of drilling performance prediction. For example, a field example using the described techniques to predict ROP based on porosity data from well logs together with the developed porosity-rock strength correlation (see FIG. 3) resulted in predicted drilling time accurate to within 5% of real data.

### Components, and Logic of Example Embodiments

Certain embodiments are described herein as including logic or a number of components, modules, mechanisms, computer processor devices or other hardware components configured to perform specified automated tasks, processes or operations. Such components comprise hardware-implemented modules. A hardware-implemented module is a tangible unit capable of performing certain operations and may be configured or arranged in a certain manner. In example embodiments, one or more computer systems (e.g., a standalone, client, or server computer system) or one or more processors may be configured by software (e.g., an application or application portion) as a hardware-implemented module that operates to perform certain operations as described herein. Logic circuitry of the processor is in such cases temporarily configured by the software executed thereon to perform specific task. As is well known to persons knowledgeable in the field, execution of a software program by a reconfigurable processor physically reconfigures the processor to provide for circuitry that is specially configured to perform particular non-generic tasks.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry or in temporarily configured circuitry (e.g., configured by software), may be driven by cost and time considerations.

Accordingly, the terms hardware-implemented module, circuitry configured to perform specified tasks, or a computer processor device configured to perform certain tasks should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which such hardware-implemented components are temporarily configured (e.g., programmed), each of the hardware-implemented components/modules need not be configured or instantiated at any one instance in time. For example, where the hardware-implemented components comprise a processor temporarily configured using software, the processor may be configured as respective different hardware-implemented components at different times. Software may accordingly configure a processor, for example, to constitute a particular hardware-implemented module, device, or component at one instance of time and to constitute a different hardware-implemented module, device, or component at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., Application Program Interfaces (APIs).)

FIG. 9 illustrates an exemplary control system 900 for controlling operation of the drill string 108, the control system 900 including a computing subsystem 902 according to one example embodiment. Computing subsystem 902 may be located at or near one or more well bores of drilling system 100 or at a remote location. All or part of computing subsystem 902 may operate as a component of or independent of drilling system 100 or independent of any other components shown in FIG. 1 and FIG. 2.

Computing subsystem 902 includes a memory 904, a processor 914, and input/output controllers 918 communicatively coupled by a communication bus 916. Processor 914 may include hardware for executing instructions, such as those making up a computer program, such as applications 912. As an example and not by way of limitation, to execute instructions, processor 914 may retrieve (or fetch) the instructions from an internal register, an internal cache, and/or memory 904; decode and execute them; and then write one or more results to an internal register, an internal cache, and/or memory 904. This disclosure contemplates processor 914 including any suitable number of any suitable internal registers, where appropriate. Where appropriate, processor 914 may include one or more arithmetic logic units (ALUs); be a multi-core processor; or include one or more processors. Although this disclosure describes and illustrates a particular processor, this disclosure contemplates any suitable processor. In some embodiments, processor 914 may execute instructions, for example, to generate output data based on data inputs. For example, processor 914 may run applications 912 by executing or interpreting software, scripts, programs, functions, executables, or other modules contained in applications 912.

The processor 914 thus provides, in this example embodiment, circuitry which is temporarily configured to perform automated control and/or optimization operations as described. Instead or in addition, one or more processors or computing modules of the control system 900 may be provided by permanently configured circuitry, such as hardwired computing components and application-specific integrated circuits (ASICs) specifically configured to performed one or more of the automated optimization and/or control methodologies described herein without execution

Processor 914 may perform one or more operations related to FIGS. 3-7. Input data received by processor 914 or output data generated by processor 914 may include formation properties 906, drill bit properties 908, and logging data 910. Memory 904 may include, for example, random access memory (RAM), a storage device (e.g., a writable read-only memory (ROM) or others), a hard disk, a solid state storage device, or another type of storage medium. Computing subsystem 902 may be preprogrammed or it may be programmed (and reprogrammed) by loading a program from another source (e.g., from a CD-ROM, from another computer device through a data network, or in another manner). In some embodiments, input/output controllers 918 may be coupled to input/output devices (e.g., monitor 20, a mouse, a keyboard, or other input/output devices) and to communication link 280. The input/output devices may receive and transmit data in analog or digital form over communication link 280. Memory 904 may store instructions (e.g., computer code) associated with an operating system, computer applications, and other resources. Memory 904 may also store application data and data objects that may be interpreted by one or more applications or virtual machines running on computing subsystem 902. For example, formation properties 906, drill bit properties 252, logging data 910, and applications 912 may be stored in memory 904. In some implementations, a memory of a computing device may include additional or different data, applications, models, or other information. Formation properties 906 may include information that may be used to determine the properties of the formation (e.g., the volume percentage of shale and sandstone, gamma ray readings, confined rock strengths, and/or unconfined rock strength). Drill bit properties 252 may include information that may provide information about the drill bit (e.g., the diameter of a drill bit, the diameter of a cutting element, the volume of the cutting element, the placement of the cutting element on the drill bit, rock-drill bit interaction constant, and/or bit wear coefficients). Logging data 910 may include information on the logging performed in subterranean region 104 (e.g., gamma ray readings performed in the wellbore). Values from formation properties 906, drill bit properties 908, and logging data 910 may be used to calculate the wear of a cutting element on a drill bit. Applications 912 may include software applications, scripts, programs, functions, executables, or other modules that may be interpreted or executed by processor 914. Applications 912 may include machine-readable instructions for performing one or more operations described herein. Applications 912 may include machine-readable instructions for optimizing ROP and/or energy of the drilling operation based on realtime formation property measurements that include one or more rock brittleness correlate. Applications 912 may generate output data and store output data in memory 904, in another local medium, or in one or more remote devices (e.g., by sending output data via communication link 922). Communication link 280 may include any type of communication channel, connector, data communication network, or other link. For example, communication link 922 may include a wireless or a wired network, a Local Area Network (LAN), a Wide Area Network (WAN), a private network, a public network (such as the Internet), a wireless network, a network that includes a satellite link, a serial link, a wireless link (e.g., infrared, radio frequency, or others), a parallel link, or another type of data communication network. Generally, the techniques described here may be performed at any time, for example, before, during, or after a subterranean operation or other event. In some instances, the techniques described may be implemented in real time, for example, during a drilling operation. Additionally, computing subsystem 902 may be located on the surface of the wellbore or may be located downhole as part of a downhole tool or BHA 200.

The following numbered examples are illustrative embodiments in accordance with various aspects of the present disclosure, at least some of which are exemplified by the foregoing description of a detailed example embodiment.

1. A system may comprise:

a logging system configured to obtain log data indicating measurement values for one or more formation property metrics captured with respect to an underground formation through which a borehole is to be drilled in a drilling operation using a bottomhole assembly forming part of a drill string, the one or more formation property metrics including a brittleness correlate provided by a metric that has a correlational relationship with a brittleness index of the formation, so that a particular measurement value for the brittleness correlate is indicative, by correlation, of a corresponding value of the brittleness index; and

a control system comprising one or more computer processor devices configured to:
calculate, based at least in part on the log data, respective target values for one or more drilling parameters a drilling performance model that expresses a performance measure of the drilling operation as a function of the brittleness correlate and of the one or more drilling parameters, and
cause operation of the bottomhole assembly based at least in part on the calculated target values for the one or more drilling parameters.

The logging system may comprise measurement instrumentation to capture the log data. Instead, or in addition, the logging system may be provided by a data interface to receive the log data from measurement instrumentation, and may further include one or more memories storing the log data. Causing operation of the bottomhole assembly may comprise generating display information for display on an operator interface to enable operator control of the BHA based on the one or more drilling parameters. Instead, or in addition, the causing of operation of the BHA may comprise automated control of the BHA by the control system.

2. The system of example 1, in which the control system is configured to derive optimized values for the one or more drilling parameters by performing automated optimization of the drilling performance model.

3. The system of any one of the preceding examples, in which the control system is configured such that the performance measure expressed by the drilling performance model is a rate of penetration (ROP) of the bottomhole assembly through the formation. In some embodiments of example 3, the control system further may be configured to perform optimization of the drilling performance model by maximizing the ROP predicted by the drilling performance model.

4. The system of any one of examples 1 or 2, in which the control system is configured such that the performance measure expressed by the drilling performance model is an energy measure selected from the group consisting of mechanical specific energy and hydromechanical specific energy of the drilling operation. In some embodiments of example 4, the control system further may be configured to optimize the drilling performance model by minimizing the energy measure.

5. The system of any one of the preceding examples, wherein the control system is configured such that the drilling performance model includes an analytical ROP model that expresses a rate of penetration (ROP) of the bottomhole assembly through the formation as a function of a bit wear factor that quantifies wear on a drill bit forming part of the bottomhole assembly, and wherein the drilling performance model further includes an analytical bit wear model that expresses the bit wear factor as a function of ROP. In some embodiments of example 5, the control system is configured to calculate the target values for the one or more drilling parameters in an iterative operation may include recursive solution of the ROP model and the bit wear model in turn.

6. The system of any of the preceding examples, wherein the brittleness correlate is indicated by sonic log data.

7. The system of any one of examples 1-5, wherein the brittleness correlate is p-wave velocity of the formation.

8. The system of any one of examples 1-5, wherein, the brittleness correlate is indicated by porosity log data.

9. The system of any one of the preceding examples, in which the brittleness index is a B4 index given b by \sqrt{(σₜ*σ_{c})}/2, where σₜ is tensile rock strength and σ_{c} is compressive rock strength. Note that the compressive rock strength term of example 9 and the unconfined compressive strength of the example 10 may in some instances refer to the same formation property.

10. The system of any one of examples 1-8, in which the control system is configured to use unconfined compressive strength of the formation as the brittleness index.

11. The system of any one of the preceding examples, in which the log data includes measurement values for a group of different brittleness correlates, and in which the control system is configured to calculate the target values for the one or more drilling parameters using the group of different brittleness correlates.

12. The system of example 11, in which the group of different brittleness correlates includes at least two formation property metrics obtained by different respective methods of evaluating the formation.

13. The system of any of the preceding examples, in which the drilling performance model is a function of a rock drillability index that is, in turn, a function of the brittleness index.

14. The system of example 13, wherein the rock drillability index is given by the expression 1/Bₙ/(1+A*Pₑ^{b}), where a and b are model constants, Bₙ is the brittleness index, and Pₑ is a pressure difference between bottomhole pressure and pore pressure in the formation.

15. The system of any of the preceding examples, in which the logging system is configured to gather the log data in a logging while drilling operation, and in which the control system is configured to perform calculation of the target values for the one or more drilling parameters substantially in real time. In some embodiments of example 15, the log data may be obtained in a logging while drilling operation.

16. A method comprising:

obtaining log data indicating measurement values for one or more formation property metrics captured with respect to an underground formation through which a borehole is to be drilled in a drilling operation using a bottomhole assembly forming part of a drill string, the one or more formation property metrics including a brittleness correlate provided by a metric that has a correlational relationship with a brittleness index of the formation, so that a particular measurement value for the brittleness correlate is indicative, by correlation, of a corresponding value of the brittleness index;

in an automated operation based at least in part on the log data and performed using one or more computer processor devices configured to perform the automated operation, calculating respective target values for one or more drilling parameters using a drilling performance model that expresses a performance measure of the drilling operation as a function of the brittleness correlate and of the one or more drilling parameters; and

causing control of operation of the bottomhole assembly based at least in part on the calculated target values for the one or more drilling parameters.

17. The method of example 16, wherein the drilling performance model comprises an analytical ROP model that expresses a rate of penetration (ROP) of the bottomhole assembly through the formation as a function of a bit wear factor that quantifies wear on a drill bit forming part of the bottomhole assembly, and wherein the drilling performance model further comprises an analytical bit wear model that expresses the bit wear factor as a function of ROP, the calculating of the target values for the one or more drilling parameters comprising recursive solution of the ROP model and the bit wear model in turn.

18. The method of example 16 or example 17, wherein the brittleness correlate is selected from the group comprising sonic p-wave velocity of the formation and formation porosity.

19. The method of example 16 or example 17, wherein the brittleness index is provided by unconfined compressive strength of the formation.

20. The method of example 16, further comprising performance of respective operations corresponding to the features of system configuration according to any one of examples 2-15.

21. A non-transitory computer-readable storage medium having stored thereon instructions that, when executed by a machine, cause the machine to perform operations comprising:

obtaining and storing log data indicating measurement values for one or more formation property metrics captured with respect to an underground formation through which a borehole is to be drilled in a drilling operation using a bottomhole assembly forming part of a drill string, the one or more formation property metrics including a brittleness correlate provided by metric that has a correlational relationship with a brittleness index of the formation, so that a particular measurement value for the brittleness correlate is indicative, by correlation, of a corresponding value of the brittleness index;

calculating, based at least in part on the log data, respective target values for one or more drilling parameters using a drilling performance model that expresses a performance measure of the drilling operation as a function of the brittleness correlate and of the one or more drilling parameters; and

causing control of the bottomhole assembly based at least in part on the calculated target values for the one or more drilling parameters.

Although specific examples have been illustrated and described herein, it will be appreciated by those of ordinary skill in the art that any arrangement that is calculated to achieve the same purpose may be substituted for the specific examples shown. Various examples use permutations and/or combinations of examples described herein. It is to be understood that the above description is intended to be illustrative, and not restrictive, and that the phraseology or terminology employed herein is for the purpose of description. Combinations of the above examples and other examples will be apparent to those of skill in the art upon studying the above description.

What is claimed is:

1. A system comprising:
a logging system configured to obtain log data indicating measurement values for one or more formation property metrics captured with respect to an underground formation through which a borehole is to be drilled in a drilling operation using a bottomhole assembly forming part of a drill string, the one or more formation property metrics including a brittleness correlate provided by a metric that has a correlational relationship with a brittleness index of the formation, so that a particular measurement value for the brittleness correlate is indicative, by correlation, of a corresponding value of the brittleness index; and
a control system comprising one or more computer processor devices configured to:
calculate, based at least in part on the log data, respective target values for one or more drilling parameters a drilling performance model that expresses a performance measure of the drilling operation as a function of the brittleness correlate and of the one or more drilling parameters, and
cause operation of the bottomhole assembly based at least in part on the calculated target values for the one or more drilling parameters.

2. The system of claim 1, wherein the control system is configured to derive optimized values for the one or more drilling parameters by performing automated optimization of the drilling performance model.

3. The system of claim 2, wherein the control system is configured such that the performance measure expressed by the drilling performance model is a rate of penetration (ROP) of the bottomhole assembly through the formation, the control system further being configured to perform optimization of the drilling performance model by maximizing the ROP predicted by the drilling performance model.

4. The system of claim 2, wherein the control system is configured such that the performance measure expressed by the drilling performance model is an energy measure selected from the group comprising mechanical specific energy and hydromechanical specific energy of the drilling operation, the control system further being configured to optimize the drilling performance model by minimizing the energy measure.

5. The system of claim 1, wherein the control system is configured such that the drilling performance model comprises an analytical ROP model that expresses a rate of penetration (ROP) of the bottomhole assembly through the formation as a function of a bit wear factor that quantifies wear on a drill bit forming part of the bottomhole assembly, the drilling performance model further comprising an analytical bit wear model that expresses the bit wear factor as a function of ROP, and wherein the control system is configured to calculate the target values for the one or more drilling parameters in an iterative operation comprising recursive solution of the ROP model and the bit wear model in turn.

6. The system of claim 1, wherein the brittleness correlate is indicated by sonic log data.

7. The system of claim 6, wherein the brittleness correlate is p-wave velocity of the formation.

8. The system of claim 1, wherein the brittleness correlate is indicated by porosity log data.

9. The system of claim 1, wherein the brittleness index is a B4 index given by \sqrt{(σₜ*σ_{c})}/2, where σₜ is tensile rock strength and σ_{c} is compressive rock strength.

10. The system of claim 1, wherein the control system is configured to use unconfined compressive strength of the formation as the brittleness index.

11. The system of claim 1, wherein the log data includes measurement values for a plurality of different brittleness correlates, and wherein the control system is configured to calculate the target values for the one or more drilling parameters using the plurality of different brittleness correlates.

12. The system of claim 11, wherein the plurality of different brittleness correlates comprises at least two formation property metrics obtained by different respective methods of evaluating the formation.

13. The system of claim 1, wherein the drilling performance model is a function of a rock drillability index that is, in turn, a function of the brittleness index.

14. The system of claim 13, wherein the rock drillability index is given by the expression 1/Bₙ/(1+A*Pₑ^{b}), where a and b are model constants, Bn is the brittleness index, and Pₑ is a pressure difference between bottomhole pressure and pore pressure in the formation.

15. The system of claim 1, wherein
the logging system is configured to gather the log data in a logging while drilling operation; and
the control system is configured to perform calculation of the target values for the one or more drilling parameters substantially in real time, the log data being obtained in a logging while drilling operation.

16. A method comprising:
obtaining log data indicating measurement values for one or more formation property metrics captured with respect to an underground formation through which a borehole is to be drilled in a drilling operation using a bottomhole assembly forming part of a drill string, the one or more formation property metrics including a brittleness correlate provided by a metric that has a correlational relationship with a brittleness index of the formation, so that a particular measurement value for the brittleness correlate is indicative, by correlation, of a corresponding value of the brittleness index;
in an automated operation based at least in part on the log data and performed using one or more computer processor devices configured to perform the automated operation, calculating respective target values for one or more drilling parameters using a drilling performance model that expresses a performance measure of the drilling operation as a function of the brittleness correlate and of the one or more drilling parameters; and
causing control of operation of the bottomhole assembly based at least in part on the calculated target values for the one or more drilling parameters.

17. The method of claim 16, wherein the drilling performance model comprises an analytical ROP model that expresses a rate of penetration (ROP) of the bottomhole assembly through the formation as a function of a bit wear factor that quantifies wear on a drill bit forming part of the bottomhole assembly, and wherein the drilling performance model further comprises an analytical bit wear model that expresses the bit wear factor as a function of ROP, the calculating of the target values for the one or more drilling parameters comprising recursive solution of the ROP model and the bit wear model in turn.

18. The method of claim 17, wherein the brittleness correlate is selected from the group comprising sonic p-wave velocity of the formation and formation porosity.

19. The method of claim 16, wherein the brittleness index is provided by unconfined compressive strength of the formation.

20. A non-transitory computer-readable storage medium having stored thereon instructions that, when executed by a machine, cause the machine to perform operations comprising:
obtaining and storing log data indicating measurement values for one or more formation property metrics captured with respect to an underground formation through which a borehole is to be drilled in a drilling operation using a bottomhole assembly forming part of a drill string, the one or more formation property metrics including a brittleness correlate provided by metric that has a correlational relationship with a brittleness index of the formation, so that a particular measurement value for the brittleness correlate is indicative, by correlation, of a corresponding value of the brittleness index;
calculating, based at least in part on the log data, respective target values for one or more drilling parameters using a drilling performance model that expresses a performance measure of the drilling operation as a function of the brittleness correlate and of the one or more drilling parameters; and
causing control of the bottomhole assembly based at least in part on the calculated target values for the one or more drilling parameters.
